(19) United States
(12) Patent Application Publication
(10) Pub. No.: US 2016/0159525 A1
(43) Pub. Date: Jun. 9, 2016

(54) PAPER/PLASTIC-FILM CARRIER BAG AND METHOD FOR MANUFACTURING PLASTIC-FILM CARRIER BAG

(71) Applicant: Chidoriya Souke Co., Ltd., Amagasaki-City (JP)

(72) Inventor: Tashichiro HARADA, Nishinomiya-City (JP)

(21) Appl. No.: 14/918,610

(22) Filed: Oct. 21, 2015

(30) Foreign Application Priority Data
Dec. 3, 2014 (JP) 2014-244914
Feb. 17, 2015 (JP) 2015-029090

(51) Int. Cl. B65D 33/06; B31B 1/64; B31B 1/86; B31B 1/20

(52) U.S. Cl. CPC B65D 33/065; B31B 1/20; B31B 1/64; B31B 1/86

(57) ABSTRACT

A paper/plastic-film carrier bag, includes: a cylindrical receiving portion, which is configured to receive an approximately cubic-shaped article; and a long-shaped handgrip portion, being formed extending from one of upper sides of said cylindrical receiving portion, on a side of which is in contact any one of sides of the approximately cubic-shaped article, and reaching to another upper side of the cylindrical receiving portion facing thereto. And a method for manufacturing the above, in particular, the plastic-film carrier bag, comprises the following steps of: a step of producing a fully-closed sack by conducting a welding process on a cylindrical plastic film progressing in an in-line process, for sealing a portion to be a side surface of the plastic-film carrier bag and separating from; a step of removing an unnecessary portion from one or plural pieces of said fully-closed sack(s) being piled up.

### BACKGROUND OF THE INVENTION

The present invention relates to a paper carrier bag or a plastic-film carrier bag (hereinafter, being called a “paper/plastic-film carrier bag”) for receiving or putting goods therein and a method for manufacturing the above, and in particular, it relates to a paper/plastic-film carrier bag, being suitable for putting or receiving a cubic box or boxes therein, each storing foods or the like therein, for example, to be carried by hand (i.e., being portable), and further a method for manufacturing the above, in particular, the plastic-film carrier bag, among of the paper made carrier bag and the plastic-film made carrier bag.

A disposable carrier bag made of a paper or a plastic film (e.g., a polyethylene film or a polypropylene film), which can be carried by hand, is widely used in shops or stores, such as, a supermarket, etc. Such carrier bag made of the paper or the plastic film, being cheap in price and light in weight, and also being high in the strength thereof, and further having characteristics of being superior in waterproof property thereof, is called “a disposable carrier bag” or “a plastic shopping bag”, and it is used, in the place of an ordinary shopping bag for putting the purchased goods therein, to be carried by hand.

The disposable carrier bag made of a cylindrical carrier bag, to be used in the supermarket, etc., being formed with hand gripping pieces in part thereof, is used for the purpose of putting the goods therein, which may have various kinds of shapes, such as, vegetables, packed meats, foods packed by a maker, etc.; i.e., as a portable shopping bag, which can be carried by hand. As one of those disposable carrier bags is already known such that, as is described in the following Patent Document 1.

The disposable carrier bag described in the Patent Document 1 is so designed that the goods can be put within a receiving space of that disposable carrier bag, cleverly and effectively.

[Patent Document 1] Japanese Patent Laying-Open No. 2006-131250 (2006)

### BRIEF SUMMARY OF THE INVENTION

The disposable carrier bag described in the Patent Document 1 mentioned above can hold a long bottle or the like therein, in a manner of standing, not falling or tumbling down, and it can also keep a lunch box or a box for keeping a cake(s) therein, etc., being horizontal in the condition thereof; i.e., being able to protect the goods from falling down when carrying that. However, it has a problem, in particular, in case of carrying the disposable carrier bags in plural numbers thereof, at the same time; i.e., there is still a possibility that the goods within the disposable carrier bag may fall or tumble down, when holding the disposable carrier bag together with a bag, and in particular, with such lunch box or the box keeping the cake(s) therein, being put in the bag, it cannot keep the condition of being horizontal.

According to the present invention, accomplished by taking the problem(s) mentioned above into the consideration thereof, an object thereof is to provide a paper/plastic-film carrier bag, for enabling to keep such a box-like article(s) in the horizontal condition, even in cases when holding the paper/plastic-film carrier bag while putting the box-like article(s) therein, together with another shopping bag, and/or when holding that together with other paper/plastic-film carrier bag(s), at the same time, and also to provide a manufacturing method of the same, in particular, for enabling manufacture of that plastic-film carrier bag, among of the paper made carrier bag and the plastic-film made carrier bag, easily.

According to the present invention, a first distinctive feature thereof lies in a paper/plastic-film carrier bag, comprising: a cylindrical receiving portion, which is configured to receive an approximately cubic-shaped article therein; and a long-shaped handgrip portion, being formed extending from one of upper sides of said cylindrical receiving portion, on a side of which is in contact any one of sides of said approximately cubic-shaped article, and reaching to another upper side of said cylindrical receiving portion facing thereto.

This is because, when the approximately cubic-shaped article (i.e., goods or a box or boxes) is received in the paper/plastic-film carrier bag, the opening portion of the receiving portion can also change into an oblong shape, approximately, fitting to the shape of the article; therefore, the long-shaped (or ribbon-like) handgrip portion is provided, extending from one upper side of this opening portion and reaching to another upper side facing thereto.

In case of an ordinary carrier bag, the handgrip portion is formed extending among from one of four (4) corners of the opening portion having an approximate oblong shape and reaching to the other one, i.e., from two (2) upper sides, coming cross with each other, to other two (2) upper sides; therefore, when the carrier bag is held together with a bag or when it is held together with other carrier bag(s) at the same time, it inclines, obliquely, and due to this, if that article is a lunch box, a box keeping a cake(s) therein, or the like, for example, then the contents of those collide on themselves, and the outer shapes thereof are collapsed. On the contrary to this, since the paper/plastic-film carrier bag, according to the present invention, has the upper sides facing to each other, which are connected with, then the handgrip portion defines an isosceles triangle, close to an equilateral or regular triangle, having an inner side of the handgrip portion as the oblique sides or legs thereof, and therefore, an inclination of the article can be absorbed so that it can be kept to be horizontal.

A second distinctive feature of the paper/plastic-film carrier bag, according to the present invention, lies in the paper/plastic-film carrier bag, as described in the above, wherein said handgrip portion is formed, starting from the upper side of said receiving portion on the side in contact with a long side of said approximately cubic-shaped article, and reaching to the upper side facing thereto, when said approximately cubic-shaped article is defined by oblong rectangles.

This means that the long-shaped (or, a ribbon-like) handgrip portion is provided, extending from one of the upper sides of the opening portion, on the side of which is contact with a long side of that article, and reaching to another upper side facing thereto, in particular, when the approximately cubic-shaped article (i.e., goods or a box) is a cube defined by oblongs. In case where the article to be received has a regular square on the bottom surface thereof, the handgrip portion may be provided, extending from any one of the upper sides and reaching to another upper side facing thereto; however, in case of the cube defined by the oblongs, the handgrip portion is provided on the upper side in contact with a long side.

A third distinctive feature of the paper/plastic-film carrier bag, according to the present invention, lies in the paper/plastic-film carrier bag, as described in the above, wherein said handgrip portion is made by two (2) pieces of long-shaped members, extending from both ends of the upper side of said receiving portion and reaching to both ends of the upper end facing thereto, respectively.

The handgrip portion may be provided by one (1) piece or two (2) pieces thereof, as far as, it/they connect(s) between the upper sides themselves; however, in accordance with the present invention, the handgrip portion is made by two (2) pieces of ribbon-like long shaped members, which are provided on both sides of each of the upper sides.

A first distinctive feature of a method for manufacturing the plastic-film carrier bag, among of those paper and the plastic-film carrier bags according to the present invention, lies in that it comprises the following steps of: a step of producing a fully-closed sack by conducting a welding process on a cylindrical plastic film progressing in an in-line process, for sealing a portion to be a side surface of the plastic-film carrier bag and separating from; a step of removing an unnecessary portion from one or plural pieces of said fully-closed sack(s) piled up, on a side of a handgrip portion, along one edge thereof being in parallel with a direction of progress of said in-line process; and thereby manufacturing the plastic-film carrier bag described in the above.

This relates to the method for manufacturing the carrier bags, described in the first, the second or the third feature mentioned above, in particular, the plastic-film carrier bag, and it relates to a method of producing a fully-closed sack in the in-line method, by conducting the welding process on a cylindrical plastic film progressing in the in-line method, for the purpose of sealing the portion to be the side surface of the plastic-film carrier bag, as well as, separating it from. There are also cases where the folding portion(s) are/is formed on both or one of the edges of the cylindrical plastic film, in parallel with the direction of progress thereof in the line method, or where no such folding is formed. In the case where no such folding is formed, the fully-closed flat film is produced in the welding process. Conventionally, the unnecessary portion(s) is/are removed from, so that the both edges of the film, which is separated in the welding process, come to the vicinity of the upper end of the handgrip portion of the carrier bag, and also come to a bottom side defining the receiving portion thereof; however, according to the present invention, by removing the unnecessary portion(s) from the edge in parallel with the direction of progress in the line method, the handgrip portion can be defined on the one edge while defining the receiving portion on the edge of the opposite side thereof; thereby manufacturing the plastic-film carrier bag, as described in the first, the second or the third feature. Also, the configuration of the unnecessary portion can be changed in various kinds of shapes, depending on the presence/absence of the folding portion(s) and/or an amount of folding. Further, the number of the unnecessary portion(s) is two (2), in case where the handgrip portion is made up with one (1) piece of ribbon-like long-shaped member, including the side surface of the plastic-film carrier bag therein, and it is three (3), in case where the handgrip portion is made up with two (2) pieces of ribbon-like long members, including the side surface of the plastic-film carrier bag therein.

A second distinctive feature of a method for manufacturing the plastic-film carrier bag, according to the present invention, lies in that it comprises the following steps of: a step of conducing a sealing process on a cylindrical plastic film progressing in an in-line process, on a portion to be a side surface of the plastic-film carrier bag; a step of removing an unnecessary portion from said plastic film after said sealing process, on a side of a handgrip portion, along one edge thereof being in parallel with a direction of progress of said in-line process; a step of cutting and separating a welding portion or an adhesion portion, which is formed on said plastic film after said sealing process; and thereby manufacturing the plastic-film carrier bag, described in the first, the second or the third feature, in the in-line method.

This relates to the invention of a method for manufacturing the plastic-film carrier bag, as described in the first, the second or the third feature mentioned above, i.e., by conducting the sealing process, the process for removing the unnecessary portion, and the cutting process upon the cylindrical plastic film progressing in the in-line method, and thereby manufacturing such plastic-film carrier bag, as described in the above, in the in-line method.

A third distinctive feature of a method for manufacturing the plastic-film carrier bag, according to the present invention, lies in that it comprises the following steps of: a step of removing an unnecessary from a plastic film progressing in an in-line process, on a side of a handgrip portion along one edge being in parallel with a direction of the progress of said in-line process; a sealing process on a cylindrical plastic film progressing in an in-line process, on a portion to be a side surface of the plastic-film carrier bag; a step of cutting and separating a welding portion or an adhesion portion, which is formed on said plastic film after said sealing process; and thereby manufacturing the plastic-film carrier bag described in the first, the second or the third feature, in the in-line method.

This relates to the invention of a method for manufacturing the plastic-film carrier bag, as described in the first, the second or the third feature mentioned above, i.e., by conducting the welding process, after conducting the process for removing the unnecessary portion, upon the cylindrical plastic film progressing in the in-line method, thereby manufacturing such plastic-film carrier bag, as described in the above.

A fourth distinctive feature of a method for manufacturing the plastic-film carrier bag, according to the present invention, lies in that, within the method for manufacturing the plastic-film carrier bag described in the first or the third feature, as mentioned above, in place of said welding process, it further comprises the following steps: a step of conducting sealing process on said plastic film after said removing step, for sealing the portion to be the side surface of the plastic-film carrier bag; and a step of conducting a process for cutting and separating a welding portion or an adhesion portion, which is formed on said plastic film after said sealing process.

This means that the cutting process is conducted after conducting the sealing process, in the place of the welding process for conducting the sealing and the separating, approximately, at the same time.

A fifth distinctive feature of a method for manufacturing the plastic-film carrier bag, according to the present invention, lies in that, within the method for manufacturing the plastic-film bag described in any one of the first to the fourth features, as mentioned above, it further comprises the following step: a step of forming a folding portion in said cylindrical plastic film, on both or one of edges thereof being in parallel with the direction of progress of said in-line process; and wherein said folding portion is included in said unnecessary portion, when said folding portion is formed on the side of the handgrip portion of the plastic-film carrier bag.

This means that, in case where the folding portions (i.e., gussets) are formed on both edges of the cylindrical plastic film progressing in the in-line method, or where the folding portion (i.e., a gusset) is formed on one edge of the cylindrical plastic film, i.e., on the side of the handgrip portion, the folding portion (i.e., gusset) is formed so that the unnecessary portion on the side of the handgrip portion includes the folding portion (i.e., gusset) therein. With this, since the folding portion(s) (i.e., gusset(s)) can be removed as the unnecessary portion, then the handgrip portion(s) can be formed by extending the folding portion (i.e., gusset) of the remaining portion.

With the plastic-film carrier bag, according to the present invention, there can be obtained an effect of enabling to maintain the box-like article(s) in the horizontal condition, even when holding the plastic-film carrier bag while receiving the box-like article(s) therein, together with a bag(s), and/or when holding that together with other plastic-film carrier bag(s).

With the manufacturing method of the plastic-film carrier bag, according to the present invention, there can be obtained an effect of enabling to manufacture the carrier bag, in particular, the plastic-film carrier bag, which can maintain the box-like article(s) in the horizontal condition, even when holding the plastic-film carrier bag, which receives the box-like article(s) therein, together with a bag(s), and/or when holding that together with other plastic-film carrier bag(s).

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1A is a perspective view for showing an example of a condition where an article having an approximately cubic shape is put into an ordinary carrier bag, and FIG. 1B is a view for showing the condition where that bag shown in FIG. 1A is folded;

FIGS. 2A to 2C are three (3) views for showing the detailed structures thereof, where the article 20, having the approximately cubic shape, is put into the carrier bag 10 shown in FIGS. 1A and 1B, and wherein FIG. 2A is a front view thereof, FIG. 2B is a side view of that shown in FIG. 2A, and FIG. 2C is an upper view of that shown in FIG. 2A, respectively;

FIG. 3A is a view for showing the case where the carrier bag 10 shown in FIGS. 1A to 2C is held together with a bag, and FIG. 3B is a view for showing the case where it is held together with another carrier bag;

FIG. 4A is a perspective view for showing an example of the condition where an article, having the approximately cubic shape, is put into a paper/plastic-film carrier bag, according to an embodiment of the present invention, and FIG. 4B is a view for showing the condition where the plastic-film carrier bag shown in FIG. 4A is folded;

FIGS. 5A to 5C are three (3) views for showing the detailed structures thereof, when an article(s) 20 (20a, 20b), each having an approximately cubic shape, is/are put into the paper/plastic-film carrier bag 40 shown in FIGS. 4A and 4B, and wherein FIG. 5A is a front view thereof, FIG. 5B is a side view of that shown in FIG. 5A, and FIG. 5C is an upper view of that shown in FIG. 5A, respectively;

FIG. 6A shows the case when the paper/plastic-film carrier bag, according to the embodiment shown in FIGS. 4A to 5C, is held together with a bag, and FIG. 6B shows the case when it is held together with another paper/plastic-film carrier bag;

FIG. 7 is a view for showing a process of manufacturing the carrier bag, in particular, the plastic-film carrier bag, by forming a fully-closed sack from a cylindrical plastic film, having folding portions (i.e., gussets) on both ends perpendicular to the direction of progress thereof, within an in-line process, and further punching out part of that folding portions (i.e., gussets), after piling up the fully-closed bags from 10 to 100 pieces thereof, within an off-line process;

FIG. 8 is a view for showing a variation of the manufacturing process shown FIG. 7;

FIG. 9 is a view for showing a variation of the manufacturing process of shown FIG. 8;

FIG. 10 is a view for showing a process for manufacturing the plastic-film carrier bag, by removing the folding portion (i.e., gussets) from a cylindrical plastic film, having folding portions (i.e., gussets) on both ends perpendicular to the direction of progress thereof, via a punching process, and thereafter conducting a melting process thereon, within the in-line process;

FIG. 11 is a view for showing a variation of the manufacturing process shown FIG. 10;

FIG. 12 is a view for showing a variation of the manufacturing process shown FIG. 11; and

FIG. 13 is a perspective view for showing an example of the condition where the article having the approximately cubic shape is put into the plastic-film carrier bag, which is manufactured by the manufacturing method of the plastic-film carrier bag shown in any one of FIGS. 7 to 12, and this corresponds to FIG. 4A.

### DETAILED DESCRIPTION OF THE PREFERRED EMBODIMENTS

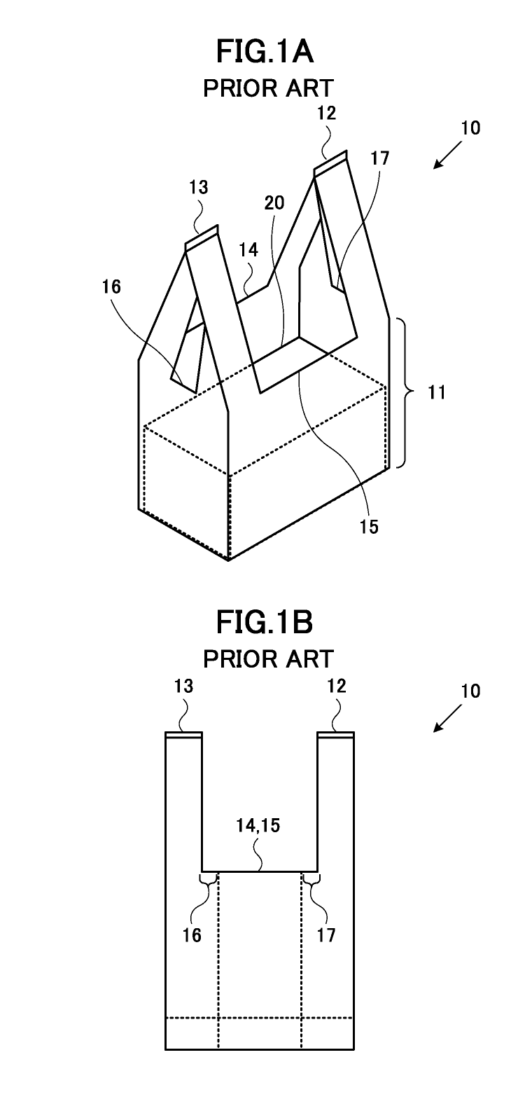

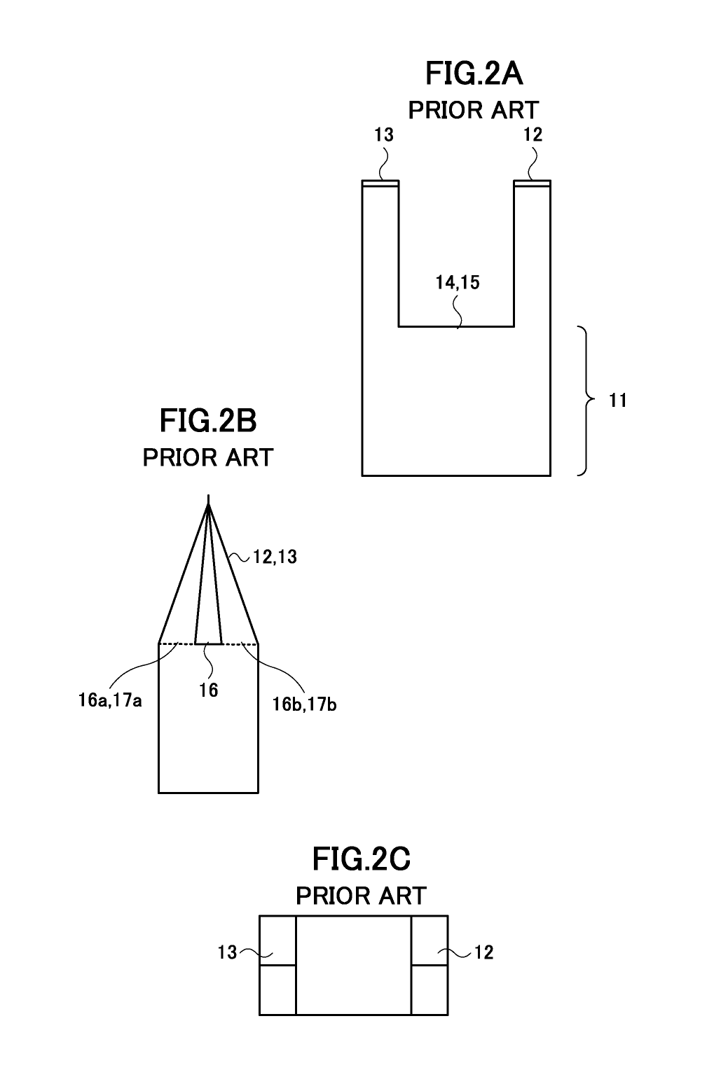

Hereinafter, embodiments according to the present invention will be fully explained, by referring to the attached drawings. FIG. 1A is a perspective view for showing an example of a condition where an article having an approximately cubic shape is put or received into an ordinary or general carrier bag 10, and FIG. 1B is a view for showing the condition where the carrier bag 10 shown in FIG. 1A is folded. FIGS. 2A to 2C are three (3) views for showing the detailed structures thereof, where an article(s) 20 (20a, 20b), each having an approximately cubic shape, is/are put into the carrier bag 10 shown in FIGS. 1A and 1B, and wherein FIG. 2A is a front view thereof, FIG. 2B is a side view of that shown in FIG. 2A, and FIG. 2C is an upper view of that shown in FIG. 2A, respectively.

As shown in FIG. 1A, the carrier bag 10 has a receiving portion 11, being made able to receive an article(s) 20 therein, each having an approximately cubic shape, and two (2) handgrip portions 12 and 13, extending upwards from upper sides 14 to 17 of the receiving portion 11.

The receiving portion 11 has a cubic shape, approximately, i.e., being defined by a bottom surface having an oblong shape, and four (4) oblong-shaped side surfaces, each rising upwards from every side of this bottom surface, and an upper surface thereof is opened. Along upper sides 14 and 15 of the receiving portion 11, there are provided knotting or tying members for the purpose of closing that opening portion; however, they are omitted herein.

Each of the handgrip portions 12 and 13 is formed from one among of four (4) corners of the oblong-shaped opening portion of the receiving portion 11 up to other one thereof, i.e., extending diagonally, upward from the corners of the upper sides 14 to 17, being perpendicular to one another, respectively, and those extending portions are connected with, in the vicinity of the upper end portions thereof, via a welding portion or an adhesion portion, which is formed in a manufacturing process; thereby defining a long-shaped tape or a ribbon to be gripped by hand. There may be a case where no such welding portion nor the adhesion portion is formed. Also, there may be a case where an opening is provided in the welding portion or the adhesion portion, to be engaged with, on a rack or the like.

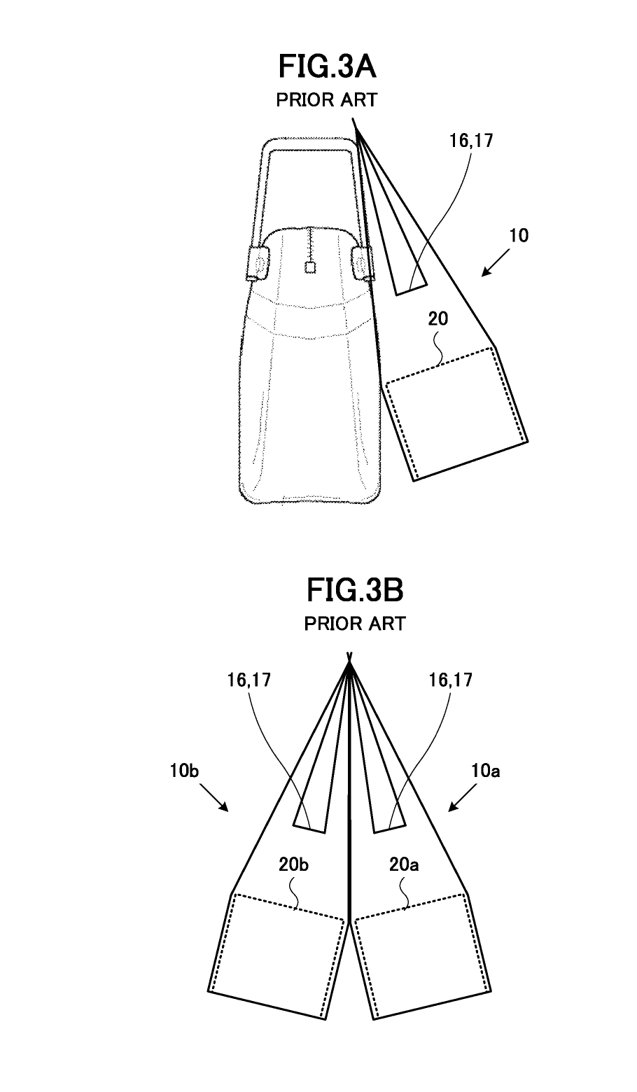

FIG. 3A is a view for showing the case where the carrier bag 10 shown in FIGS. 1A to 2C is held together with a bag, and FIG. 3B is a view for showing the case when holding that together with another carrier bag. In case where the carrier bag 10 is held together with a leather bag, for example, which is relatively large and heavy, at the same time, as is shown in FIG. 3A, an upper side portion of the article 20, having the approximately cubic shape within the carrier bag 10, is in contact with a side surface of the bag, and this results into the condition of being inclined obliquely, as it is.

In the similar manner, when holding the carrier bags 10a and 10b, at the same time, as is shown in FIG. 3B, the articles 20a and 20b, each having the approximately cubic shape, are in contact with each other, on the upper side portions thereof, then both result into the condition of being inclined obliquely, as they are.

As shown in FIGS. 3A and 3B, if the article 20, or the articles 20a and 20b, is/are a box or boxes or the like, such as, a lunch box or a box holding a cake(s) herein, for example, an oblique inclination thereof allows the contents within the lunch box or the cake(s) held in the box, to slide within the box, and thereby to move therein; i.e., having a problem that those contents collide on themselves, and thereby collapse the outlooks thereof.

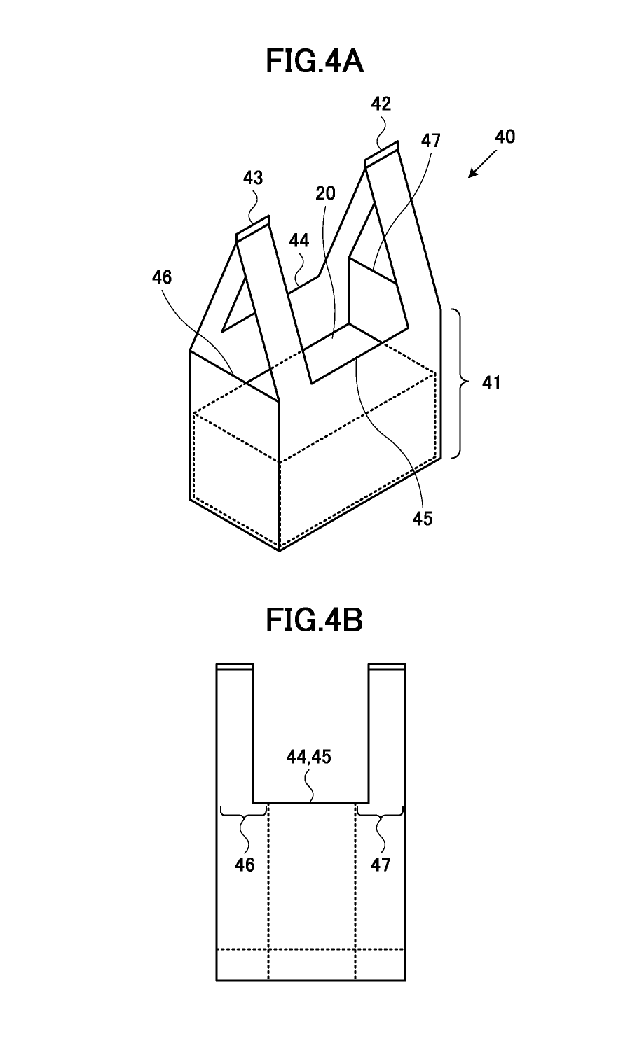

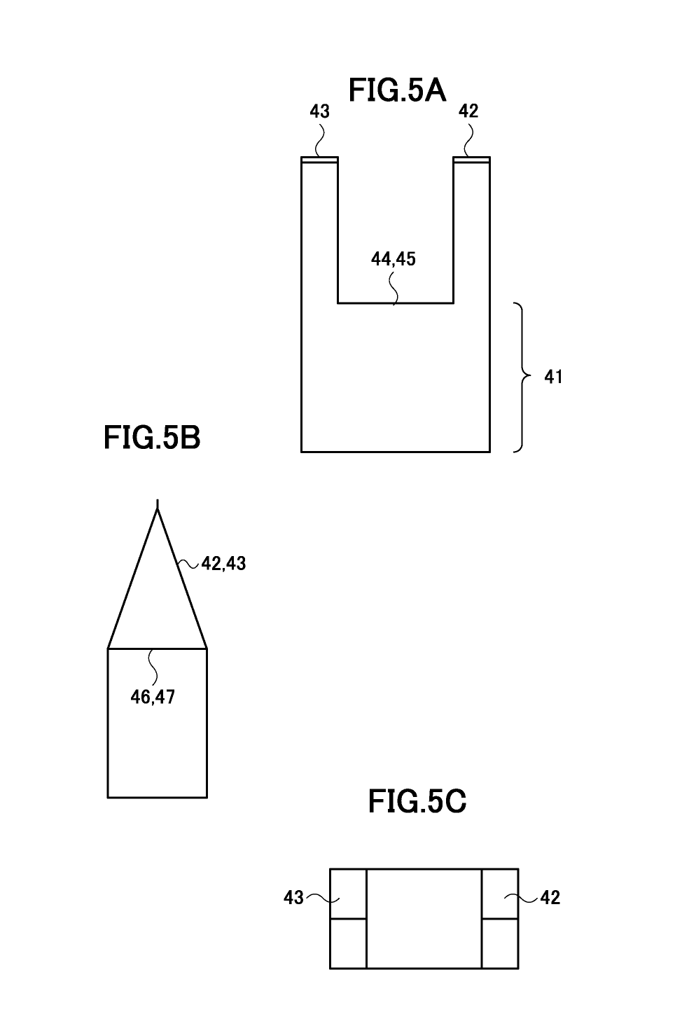

FIG. 4A is a perspective view for showing an example of the condition where an article, having an approximately cubic shape, is put into a paper/plastic-film carrier bag, i.e., being made of a paper sheet or a plastic film (e.g., a polyethylene film or a polypropylene film), according to an embodiment of the present invention, and FIG. 4B is a view for showing the condition where the paper/plastic-film carrier bag shown in FIG. 4A is folded. FIGS. 5A to 5C are three (3) views for showing the detailed structures thereof, when articles 20, each having an approximately cubic shape, are put into the paper/plastic-film carrier bag 40 shown in FIGS. 4A and 4B, and wherein FIG. 5A is a front view thereof, FIG. 5B is a side view of that shown in FIG. 5A, and FIG. 5C is an upper view of that shown in FIG. 5A, respectively. In FIGS. 4A to 5C, components having the same structures to those shown in FIGS. 1A to 2C are attached with the same reference numerals thereof.

As is shown in FIG. 4A, the paper/plastic-film carrier bag 40 has a receiving portion 41, being configured be able to receive therein an article(s) 20, each having an approximately cubic shape, and two (2) pieces of long-shaped handgrip portions 42 and 43, each extending from one long upper side 44 of the carrier bag 40, on the side of which is in contact either one of the sides of the article 20 having the approximately cubic shape, and reaching to the other long upper side 45 of the paper/plastic-film carrier bag 40 facing or opposite thereto.

The receiving portion 41 has the same structure to that of the receiving portion 11 shown in FIGS. 1A and 1B. Along long upper sides 44 and 45 of the receiving portion 41, there may be provided knotting or fastening members, for the purpose of closing the opening portion thereof.

Each handgrip portion 42 or 43 is formed extending from the long upper side of the receiving portion 41 on the side in contact with the long side of the article 20 having the approximately cubic shape, and reaching to the long side 45 facing thereto, among of four (4) sides, e.g., the long upper sides 44 and 45 and the short upper sides 46 and 47, defining the oblong-shaped opening portion of the receiving portion 41. In the vicinity of upper end of each the handgrip portions 42 or 43, it has a welding portion or an adhesion portion, which is produced in the manufacturing process thereof, in the similar manner to that of the carrier bag 10 shown in FIGS. 1A and 1B. However, it does not matter if the welding portion or the adhesion portion may not be produced. Also, an opening may be provided in the welding or the adhesion portion, to be engaged with, on a rack or the like.

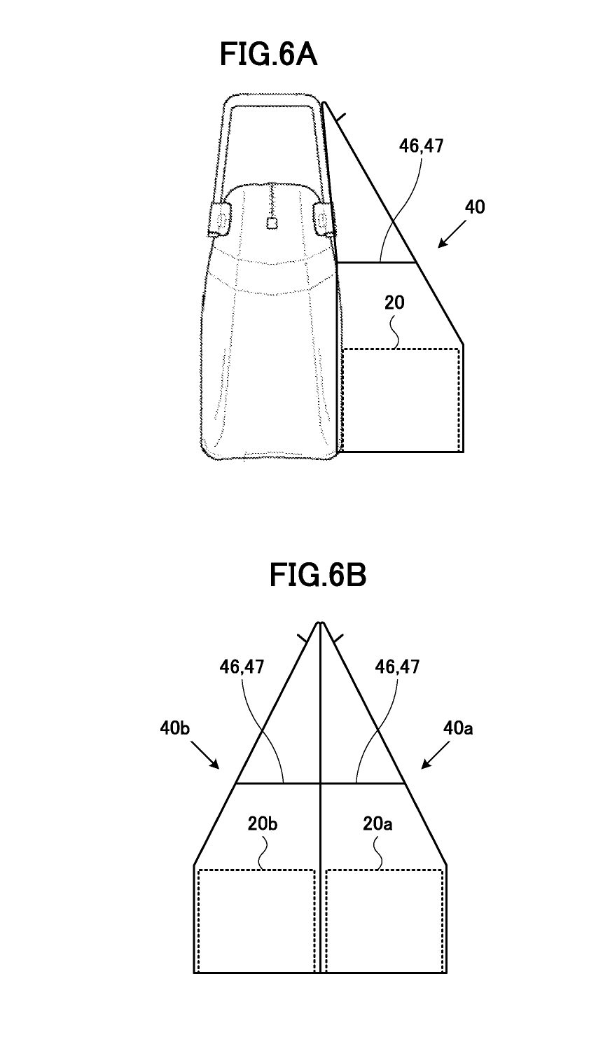

FIG. 6A shows the case when the paper/plastic-film carrier bag, according to the embodiment shown in FIGS. 4A trough 5C, is held together with a bag, and FIG. 6B shows the case when holding that together with another paper/plastic-film carrier bag. In case when holding the carrier bag 40 according to the embodiment shown in FIGS. 4A to 5C together with a lather bag, which is relatively large and heavy, at the same time, as shown in FIG. 6A, the side surface of the article 20 having the approximately cubic shape within the carrier bag 40 comes to be in contact with the side surface of the bag, closely touching on each other, so that the article 20 can maintain the horizontal condition thereof.

In the similar manner, when holing the paper/plastic-film carrier bags 40a and 40b according to the present embodiment, at the same time, as is shown in FIG. 6B, the articles 20a and 20b, each having the approximately cubic shape, come to be closely in contact with, touching on the side surfaces facing to each other; thereby those articles 20a and 20b can maintain the horizontal conditions thereof, respectively.

As shown in FIGS. 6A and 6B, even if the articles 20, 20a and 20b are boxes, such as, the lunch box and the box holding the cake(s) therein, for example, since they are possible to maintain the horizontal conditions thereof, the contents of the lunch box and/or the cake(s) or the like, being put within the box, can be carried, with stability, without sliding therein, i.e., without moving and/or colliding on each other.

The paper/plastic-film carrier bag shown in FIGS. 4A to 5C can be produced by forming such notches or cut-outs 16a and 16b, as shown by dotted lines in the hand grip portions 12 and 13, along lines extending on the upper sides 16 and 17 of the oblong-shaped opening portion of the receiving portion 11 shown in FIG. 2B; i.e. removing those hand grip portions 12 and 13 from the upper sides 16 and 17.

Portions of the hand grips 42 and 43, being removed corresponding to the cut-outs 16a and 16b, can buildup such handgrip portions 42 and 43, which are connected with only the long upper sides 44 and 45 of the oblong-shaped opening of the receiving portion 41, as is shown in FIG. 4B, by welding or adhering them with the hand grip portions 42 and 43 on the long upper sides 44 and 45. Also, in this case, width (or length), along which the handgrip portions 42 and 43 and the long upper sides 44 and 45 come across, can be selected, appropriately, depending on weight of the article(s) to be received therein; i.e., it is possible to determine the strength of the paper/plastic-film carrier bag 10 itself.

Although it is possible to produce such paper/plastic-film carrier bag, as shown in FIGS. 4A to 5C, by forming the cut-outs in the carrier bag shown in FIGS. 1A to 2C; however, it is also possible to produce such handgrip portions 42 and 43, as shown in FIGS. 4A to 5C, by means of a carrier bag manufacturing method, which will be mentioned later, in particular, relating to the plastic-film made carrier bag, among of those made of the paper and the plastic-film.

In case of holding such carrier bag 10, as is shown in FIGS. 1A to 2C, together with a bag, and holding the carrier bag 10a together with another carrier bag 10b, the article(s) within the carrier bag 10 is/are inclined, obliquely; on the contrary to the above, with provision of such handgrip portions 42 and 43, as shown in FIGS. 4A to 5C, it/they will not be inclined.

This is because, in the case of such carrier bas 10, as is shown in FIGS. 1A to 2C, length of the upper sides 16 and 17 is very short, comparing to that of the handgrip portions 12 and 13; therefore, as is shown in FIGS. 2B and 3A and 3B, the shape of an isosceles triangle, defining a bottom side thereof by the upper side 16 or 17 while the oblique lines thereof by the inner sides of the handgrip portions 12 and 13, comes to be very long and narrow (or, lean and tall). Further, when a finger(s) of hand is/are inserted into the welding portions or the adhesion portions of the handgrip portions 12 and 13, since this long and narrow triangle results into a shape of being near to a long and narrow oblong, so that the long and narrow triangle or the long and narrow oblong shape is kept as it is. For this reason, the article 20 within the carrier bag 10 comes to be inclined, obliquely.

On the contrary to the above, in case of such paper/plastic-film carrier bag 40, as is shown in FIGS. 4A to 5C, since the length of the short upper sides 46 and 47 is larger than an about half (½) of the handgrip portions 42 and 43, as is shown in FIG. 4B and FIGS. 5A to 5C; then, the isosceles triangle, defining a bottom side thereof by the short upper side 46 or 47 while oblique lines or legs thereof by the inner sides of the handgrip portions 42 and 43, respectively, comes to a shape of an equilateral triangle, approximately. Even if a finger(s) of hand is/are inserted into the welding or the adhesion portions of the handgrip portions 42 and 43, this equilateral triangle comes to be maintained as it is. For this reason, when the article 20 is inclined, obliquely, within the carrier bag 40, the positons of the welding or the adhesion portions of the handgrip portions 42 and 43 are shifted or moved outside, and then the shape of the equilateral triangle comes to a right-angle triangle, approximately, and this absorbs the inclination of the article 20, and thereby maintains the article 20 to be horizontal.

Further, by engaging the handgrip portions 42 and 43 on a handgrip holder, having hooks on both sides thereof, which is available on the market, the handgrip portions 42 and 43 slide on the hooks of the handgrip holder; thereby, enlarging the effect of maintaining the article 20 to be horizontal, much more.

With the embodiment mentioned above, the explanation was given on the case where two (2) pieces of handgrip portions 42 and 43 are provided, on both ends of the long upper sides 44 and 45, respectively; however, one (1) piece of handgrip portion may be provided in vicinity of a center of the long upper sides 44 and 45. In this case, the handgrip portion may be made of triangle-shaped ribbons, tapering to be thin as it goes from an entire of the long upper side 44 or 45 to the above.

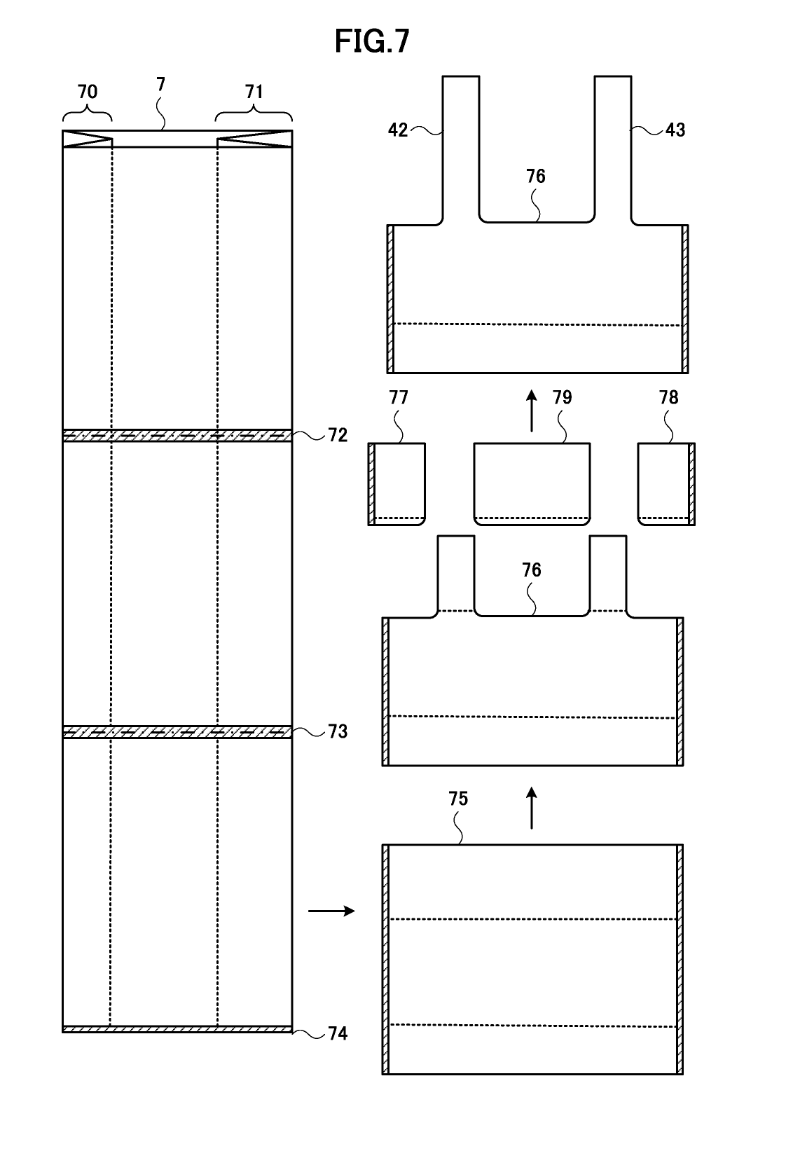

FIGS. 7 to 12 are views for showing examples of the cases when manufacturing the plastic-film carrier bag having such handgrip portions 42 and 43, as is shown in FIGS. 4A to 5C. Normally, the plastic-film carrier bags are manufactured by conducting a printing process, a sealing process, a punching process and a cutting process, etc., upon cylindrical plastic films, in an off-line method or an in-line method.

FIG. 7 is a view for showing an example of processing for manufacturing the plastic-film carrier bag; i.e., producing a totally or fully-closed sack from a cylindrical plastic film, having folding parts (i.e., gussets) on both ends or edges perpendicular to the direction of progress thereof, in the in-line, piling up the fully-closed sacks from 10 to 100 pieces thereof, in the off-line, and punching or cutting out the folding parts (i.e., gussets), partly, so as to remove them from. In FIG. 7, on both sides of the cylindrical plastic film are provided the folding parts (i.e., gussets) 70 and 71, respectively. An amount of the folding in the folding parts 70 is determined to be an about half (½) of the length of the short upper side 46 or 47, while an amount of the folding in the folding parts 71 to be an about half (½) of the length of the long upper side 42 or 43.

At each of positions 72 and 73 of the cylindrical plastic film 7, a welding process is conducted, so as to seal a portion to be a side surface of the plastic-film carrier bag 40, as well as, to separate the plastic film 7 therefrom. With this welding process is formed a welding portion or an adhesion portion at the positions 72 and 73 on the cylindrical plastic film 7. The fully-closed sack 75 is produced, separately. The length or distance between the position 72 and the position 73 is determined to be an about half (½) of the receiving portion 41 of the carrier bag 40. However, in the place of the above, after conducting only the sealing process, in advance, there may be conducted a cutting process, for cutting and separating the plastic film. 7, for each, at a position 74 in vicinity of a center of the welding or the adhesion portion. By conducting those processes (i.e., the sealing process and the cutting process) in an in-line process, the fully-closed sack 75 is produced.

After piling up the fully-closed sacks 75 from 10 to 100 pieces thereof, unnecessary portions 77 to 79, including the folding parts (i.e., gussets) 71 therein, are punched out, and those unnecessary portions 77 to 79 are removed from; i.e., a punching process is executed. A plastic-film carrier bag 76 having the handgrip portions 42 and 43 is produced, by extending the folding parts (i.e., gussets) 71 of the plastic-film carrier bag 76, which are formed through this punching process. This plastic-film carrier bag 76 differs from the plastic-film carrier bag 40 shown in FIGS. 4A to 5C, a little bit, in particular, in the shapes thereof; however, the shapes of the receiving portions of both come to be almost same, in particular, when receiving the article 20 having the approximately cubic shape therein.

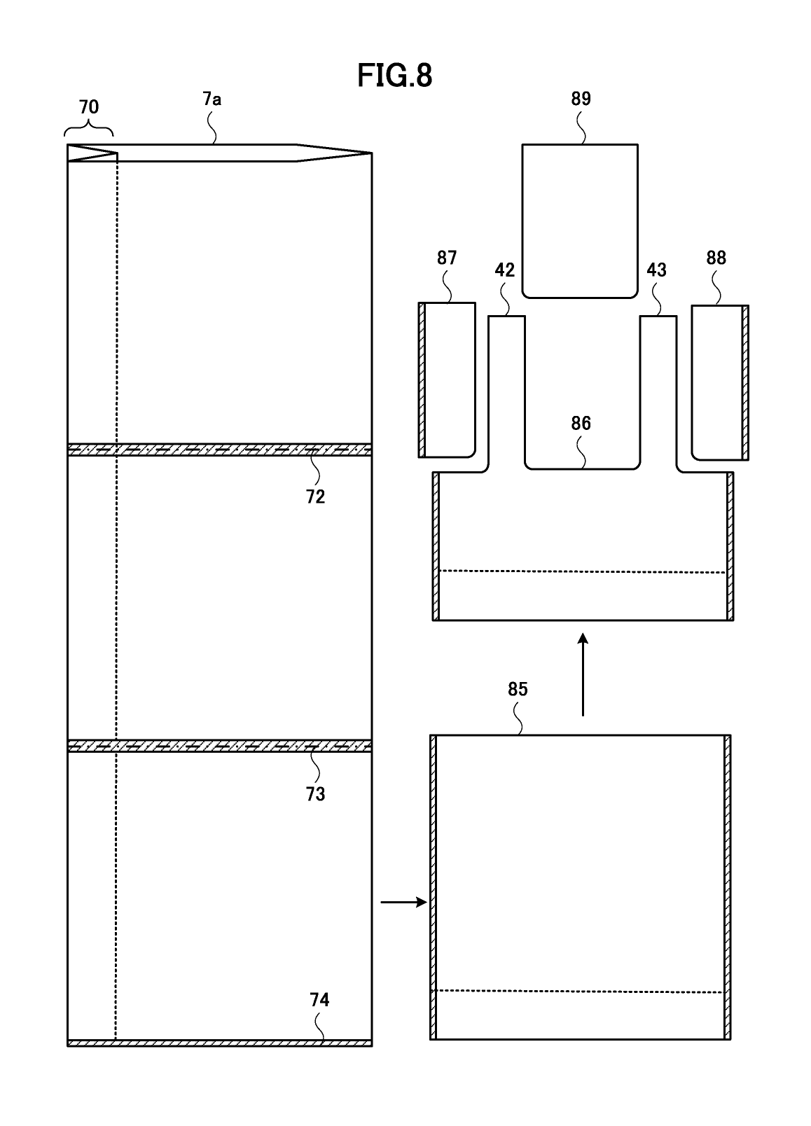

FIG. 8 is a view for showing a variation of the manufacturing method shown in FIG. 7. In this FIG. 8, since the same components to those shown in FIG. 7 are attaching with the same reference numerals thereof, therefore the explanations thereof will be omitted herein. In FIG. 8, a fully-closed sack 85 is produced from a cylindrical plastic film 7a, having a folding portion (i.e., gusset) 70 only on the side facing to the receiving portion, i.e., on one (1) edge of the carrier bag, and those fully-closed sacks 85 are piled up, from 10 to 100 pieces thereof, and unnecessary portions 87 to 89 are punched out, to be removed from; thereby manufacturing a plastic-film carrier bag 86. In FIG. 8, the folding portion (i.e., gusset) 70 is provided only on one (1) side of the cylindrical plastic film 7a; i.e., on the side facing to the receiving portion. An amount of the folding in the folding part 70 is determined to be an about half (½) of the length of the short upper side 46 or 47. This plastic-film carrier bag 86 is almost similar to the plastic-film carrier bag 76 shown in FIG. 7.

Although the explanation was given, in the embodiment shown in FIG. 8, only upon the cylindrical plastic film 7a, having the folding portion (i.e., gusset) 70 only on the side facing to the receiving portion; however, such a process for removing the unnecessary portions 77 and 78, as shown in FIG. 7, may be conducted upon the cylindrical plastic film, the folding portion (i.e., gusset) 71 of which is formed on the side of the handgrip portions 42 and 43, i.e., one (1) edge of the carrier bag.

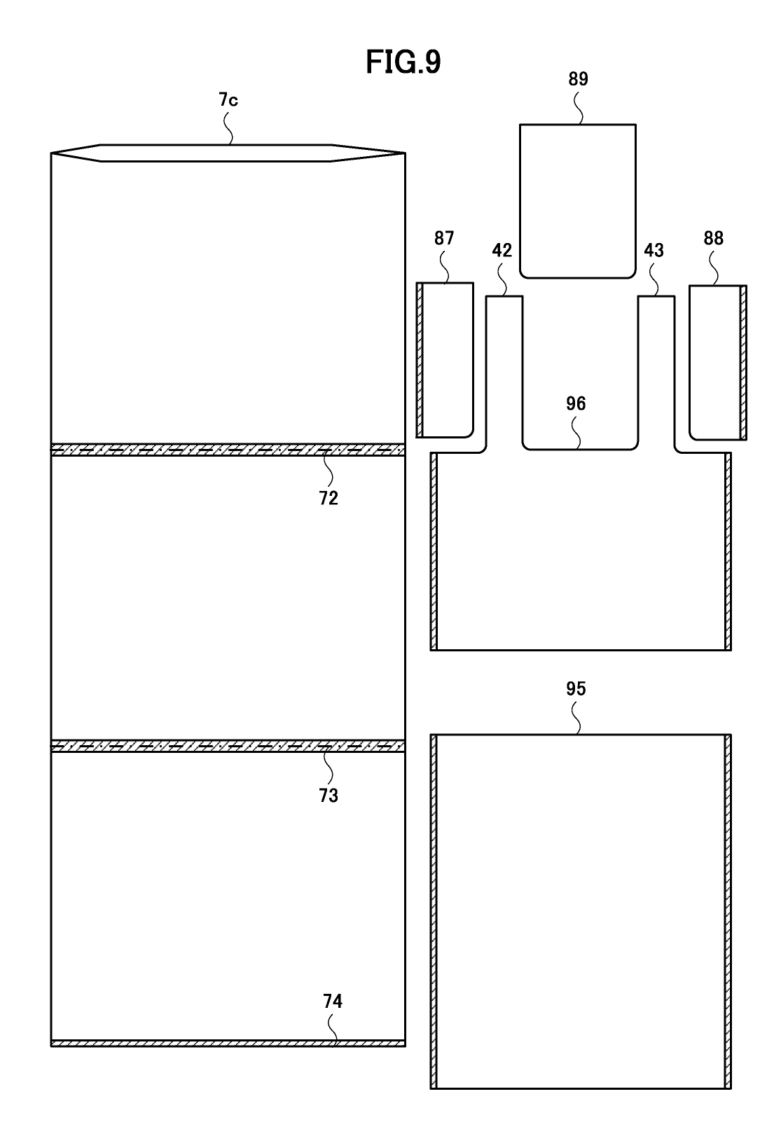

FIG. 9 is a view for showing a variation of the manufacturing method shown in FIG. 8. In this FIG. 9, the same components to those shown in FIG. 8 are attached with the same reference numerals thereof, therefore the explanations thereof will be omitted herein. In FIG. 9, by applying the cylindrical plastic film 7c, as it is, without being folded, a fully-closed plane sack 95 is produced, and the fully-closed plane sacks 95 are piled up from 10 to 100 pieces thereof, to remove the unnecessary portions 87 to 89 therefrom, via the punching out thereof; thereby, manufacturing a plastic-film carrier bag 96. With this plastic-film carrier bag 96, differing from the plastic-film carrier bag 76 shown in FIG. 7 and the plastic-film carrier bag 86 shown in FIG. 8, the length from the short upper side of the carrier bag 96 to the lower end portion thereof comes to be long, by the length of an amount of folding of the folding portion (i.e., gusset) 70 or 71 shown in FIG. 7 or 8; however, the receiving portion thereof is almost similar to those, when receiving the article 20 having the approximately cubic shape therein.

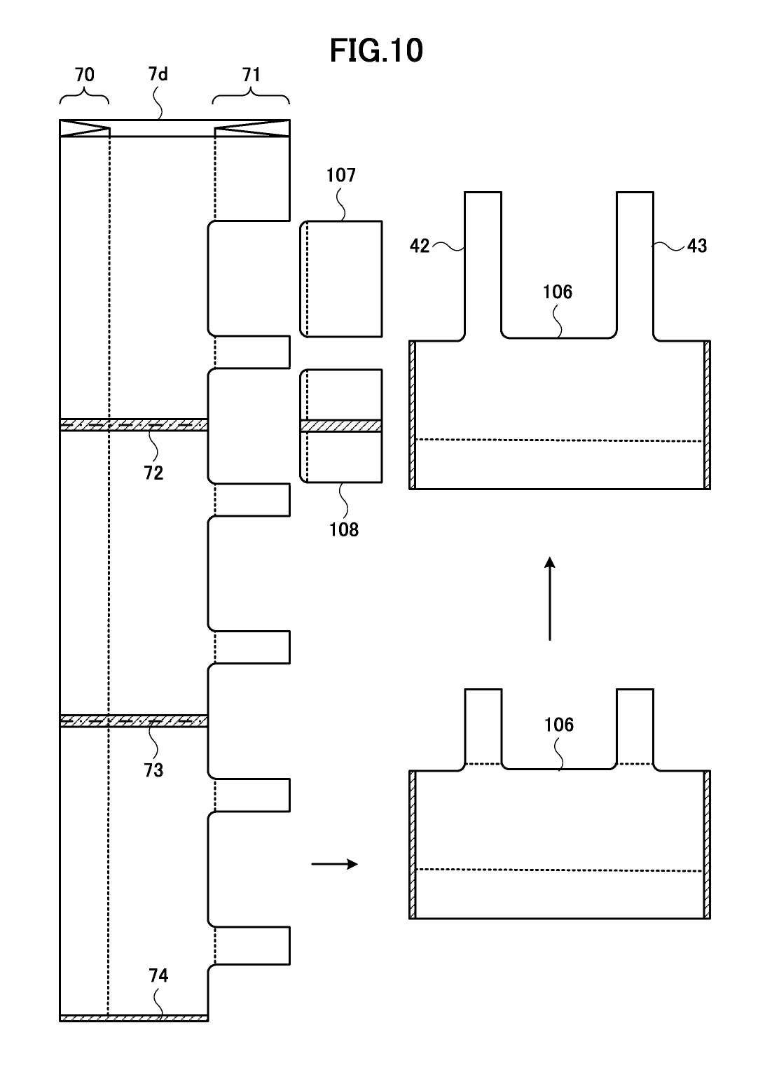

FIG. 10 is a view for showing an example of processing for manufacturing the plastic-film carrier bag, in the in-line method, i.e., by punching out the portions of the folding portions (i.e., gussets) from the cylindrical plastic film, having the folding portions (i.e., gussets) on both end or edges perpendicular to the direction of progress thereof, in the in-line method, so as to remove them from, and thereafter, by executing the welding process thereon. In this FIG. 10, since the same components to those shown in FIG. 7 are attached with the same reference numerals thereof, therefore the explanations thereof will be omitted herein. In the embodiment shown in FIG. 7, the fully-closed sacks, which are produced through the welding process, are piled up, from 10 to 100 pieces thereof, and the unnecessary portions 77 and 78 are removed from, via the punching process; however, in the embodiment shown in FIG. 10, among those folding portions (i.e., gussets) 70 and 71, which are formed on both edges (sides) of the cylindrical plastic film 7d, the unnecessary portion 107, including the folding portion (i.e., gusset) 71 therein, are removed from, via the punching process, and thereafter, they are separated from, though the welding process, i.e., a plastic-film carrier bag 106 is produced, separately.

Thus, upon the cylindrical plastic film 7d, from which the unnecessary portion 107, including the folding part (i.e., gusset) 71, is removed through the punching process, at the positions 72 and 73, the welding process is conducted for sealing the parts defining the side surfaces of the carrier bag 40, and also separating the plastic film 7d from. By this welding process is produced the plastic-film carrier bag 106, separately, on which the welding portion or the adhesion portion are formed at the positons 72 and 73 of the cylindrical plastic film 7d, in the in-line process.

However, after conducting only the sealing process, in advance, the cutting process may be conducted, at around the position 74 in vicinity of the center of the welding or the adhesion portion, for cutting and separating the plastic film 7d. Also, after conducting the sealing process before conducing the punching process, within the punching process conducted thereafter may be removed the unnecessary portion 107, including the folding portion (i.e., gusset) 71 therein, as well as, the unnecessary portion 108, including the welding portion or the adhesion portion formed in the sealing process and also the folding portion (i.e., gusset) 71, therefrom; and thereafter, the cutting process may be conducted at around the position 74 in vicinity of the center of the welding or the adhesion portion, thereby cutting and separating the plastic film 7d from.

By conducting each of those processes mentioned above in the in-line process, it is possible to produce the plastic-film carrier bag 106. By extending the folding portion (i.e., gusset) 71 of the plastic-film carrier bag produced through the cutting process, it is possible to produce the plastic-film carrier bag 106 having the handgrip portions 42 and 43. This plastic-film carrier bag 106 is same to the plastic-film carrier bag 76 shown in FIG. 7, and the shape of the receiving portion thereof comes to be nearly equal to that of the plastic-film carrier bag 40 shown in FIGS. 4A to 5C, when the article 40 having the approximately cubic shape is put therein.

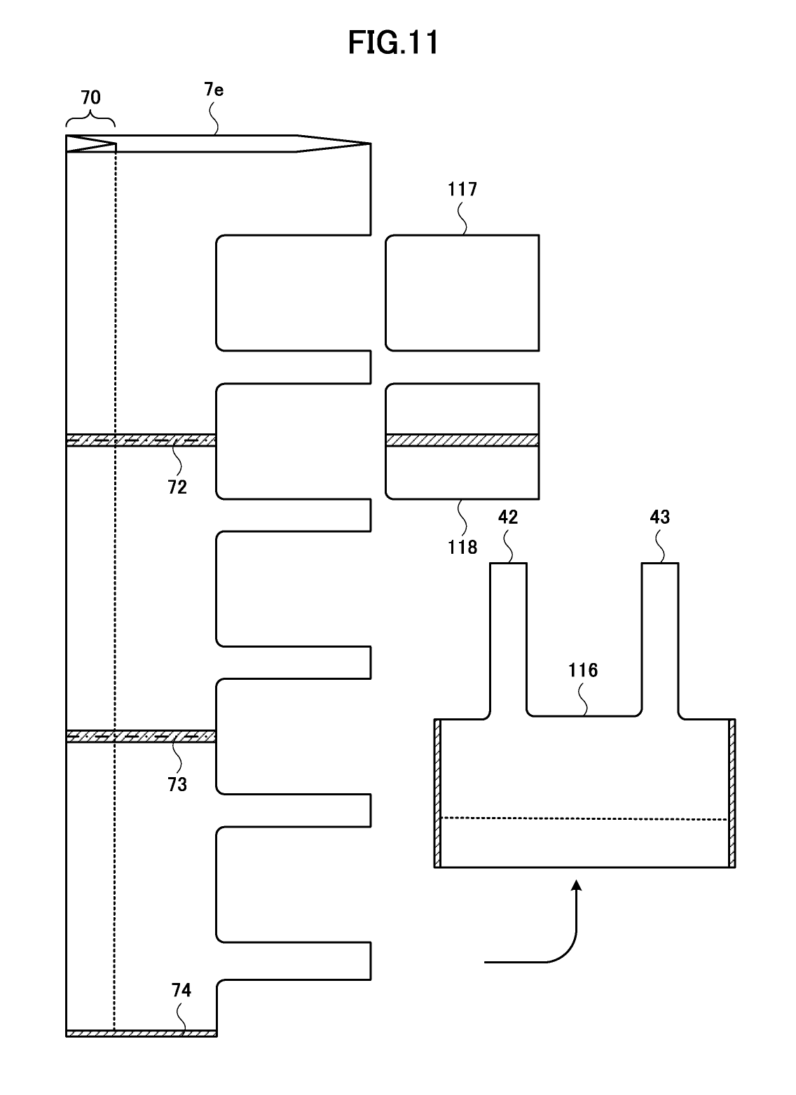

FIG. 11 is a view for showing a variation of the manufacturing method shown in FIG. 10. In this FIG. 11, since the same components to those shown in FIG. 10 are attached with the same reference numerals thereof, therefore the explanations thereof will be omitted herein. In this FIG. 11, from the cylindrical plastic film 7e, having the folding portion (i.e., gusset) 70 on the side facing to the receiving portion, i.e., on one (1) edge of the plastic-film carrier bag, an unnecessary portion 117 is removed from, via the punching process, and thereafter the film is separated from, via the welding process; thereby producing a plastic-film carrier bag 116, separately.

However, after conducting only the sealing process, in advance, the cutting process may be conducted. Also, the sealing process may be conducted before the punching process, and thereafter the punching process may be conducted, so as to remove the unnecessary portion 117, as well as, an unnecessary portion 118, including the welding portion or the adhesion portion therein, which is formed in the sealing process, therefrom; and thereafter, the cutting process may be conducted. By conducting every those processes mentioned above, it is possible to produce a plastic-film carrier bag 116 having the handgrip portions 42 and 43.

This plastic-film carrier bag 116 is same to the plastic-film carrier bag 86 shown in FIG. 8, and the shape of the receiving portion thereof comes to be same to that of the plastic-film carrier bag 40 shown in FIG. 4A to 5C. Although the explanation was given on the cylindrical plastic film 7e, having the folding portion (i.e., gusset) 70 only on the side facing to the receiving portion of the plastic-film carrier bag, in the embodiment shown in FIG. 11; however, such punching process for removing the unnecessary portions 107 and 108, as is shown in FIG. 10, may be conducted on the cylindrical plastic film, with which the folding portion (i.e., gusset) 71 is formed on the side facing to the handgrip portions 42 and 43, i.e., on one (1) edge of the plastic-film carrier bag.

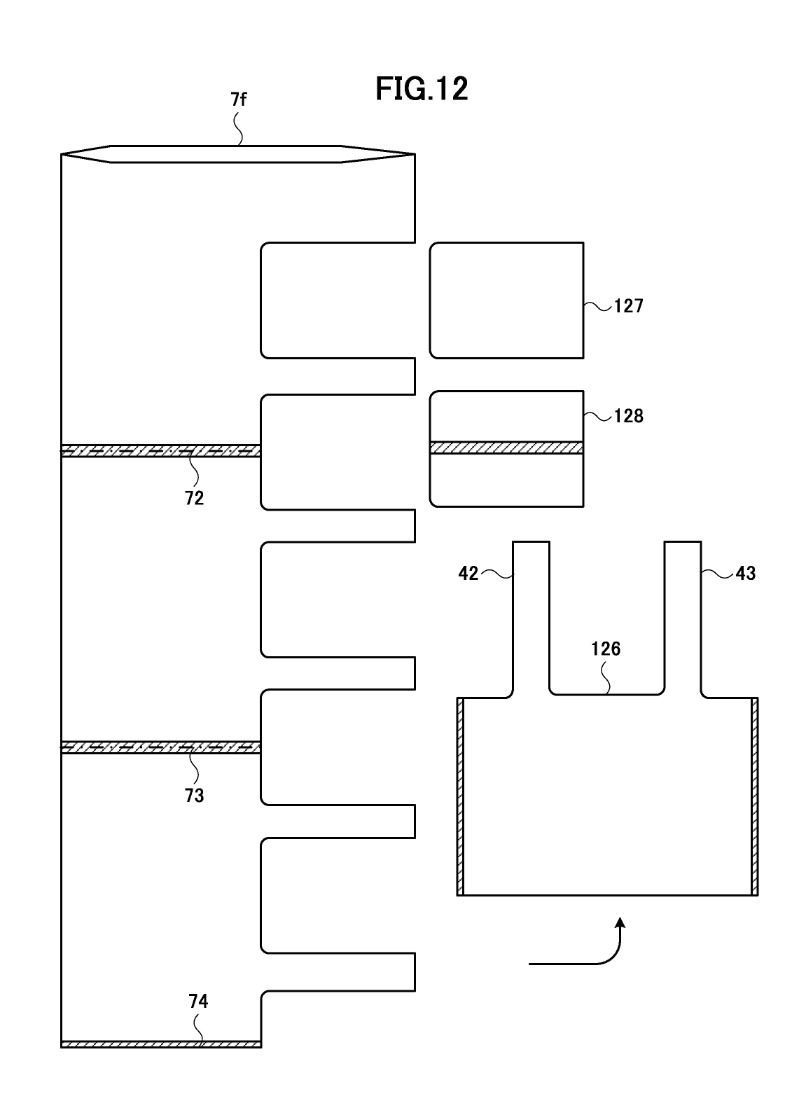

FIG. 12 is a view for showing a variation of the manufacturing method shown in FIG. 11. In this FIG. 12, since the same components to those shown in FIG. 11 are attached with the same reference numerals thereof, therefore the explanations thereof will be omitted herein. In this FIG. 12, a cylindrical plastic film 7f is applied, as it is, without being folded in part, and a plastic-film carrier bag 126 is produced, separately, by removing an unnecessary portion 127 from the cylindrical plastic film 7f and separating it, in the welding process thereafter.

However, after conducting only the sealing process, in advance, the cutting process may be conducted. Also, the sealing process may be conducted before the punching process, and thereafter, the punching process may be conducted, so as to remove the unnecessary portion 127, as well as, an unnecessary portion 128, including the welding portion or the adhesion portion formed in the sealing process, therefrom; and thereafter, the cutting process may be conducted.

By conducting every those processes mentioned above in the in-line process, it is possible to produce the plastic-film carrier bag 126 having the handgrip portions 42 and 43. This plastic-film carrier bag 126 is same to the plastic-film carrier bag 96 shown in FIG. 9, and the shape of the receiving portion thereof comes to be same to that of the plastic-film carrier bag 40 shown in FIG. 4A to 5C.

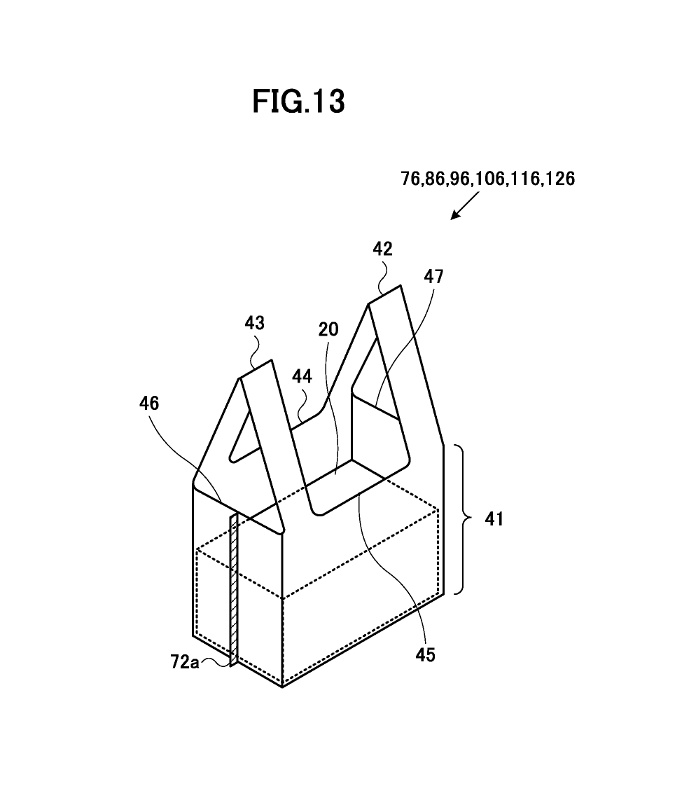

FIG. 13 is a perspective view for showing an example of the condition where the article 20, having the approximately cubic shape, is put into the plastic-film carrier bag 76, 86, 96, 106, 116 or 126, which is manufactured by the plastic-film carrier bag manufacturing method shown in any one of FIGS. 7 to 12, and this corresponds to FIG. 4A. In this FIG. 13, since the same components to those shown in FIGS. 4A and 4B are attached with the same reference numerals; therefore, the explanations thereof will be omitted, herein. An aspect of the plastic-film carrier bag 76, 86, 96, 106, 116 or 126 shown in FIG. 13 differing from that shown in FIGS. 4A and 4B, lies in that the welding or the adhesion portion 72, which is formed in the manufacturing process, still exists on the side surface of the plastic-film carrier bag 76, 86, 96, 106, 116 or 126, and other than that, it has the almost same configuration to that of the plastic-film carrier bag 40 shown in FIGS. 4A and 4B.

Width of the plastic film 7, 7a, 7b, 7c, 7d, 7e or 7f in the horizontal direction, an amount of the folding of the folding portion 71 or 72, and a size(s) of the unnecessary portion(s) 77-79, 87-89, 107, 108, 117, 118, 127 or 128 can be changed, appropriately, depending on a size of the plastic-film carrier bag to be completed, a size of the article(s) to be received therein, and the length and/or the width of the handgrip portions 42 and 43, etc.

In the embodiment mentioned above, the explanation was given on the case where the shape of the unnecessary portion 79, 107 or 108 and also the shape of the unnecessary portion 89, 117 or 118 are same to each other, respectively; however, the shape or configuration of the unnecessary portion(s) can be changed, appropriately, depending on the size of the article(s) to be received therein and the length of the handgrip portions 42 and 43.

Also, by forming the unnecessary portions 107 and 108, the unnecessary portions 117 and 118, and the unnecessary portions 127 and 128, respectively, into the same configuration, since it is enough to conduct the punching process on the same configuration, sequentially, and therefore, it is possible to simplify the punching process.

Further, when forming the unnecessary portions 107 and 108, the unnecessary portions 117 and 118, and the unnecessary portions 127 and 128, respectively, into the configurations differing from one another, it is also possible to simplify the punching process, i.e., by punching out the unnecessary portions 107 and 108, the unnecessary portions 117 and 118, and the unnecessary portions 127 and 128, at the same time.

In the embodiments shown in FIGS. 7 and 10, the explanation was given on the case where the folding portions (i.e., gussets) 70 and 71 are different in the amount of folding thereof; however, it is also possible to form the handgrip portion(s) at desirable length (or shape), by adjusting the length(s) of the unnecessary portion(s) 77-79, 107 and 108, appropriately, in a direction vertical to the direction of progress of the in-line process, while maintaining the amount of folding in the folding portions (i.e., gussets) 70 and 71 to the same. This is because of an easy implication of the invention, by changing of the configuration(s) of the unnecessary portion(s), in particular, when applying the present invention into a manufacturing method for forming the folding at the same amount thereof.

On the paper/plastic-film carrier bag shown in FIGS. 4A and 4B and FIG. 13 are formed the handgrip portions 42 and 43, on four (4) corners of the oblong-shaped opening portion of the receiving portion, i.e., at both end portions of the article 20 to be received therein, having the approximately cubic shape; however, the distance between the handgrip portions 42 and 43 can be shortened, so that the handgrip portions 42 and 43 locate near to a center, in an inside, than the four (4) corners of the oblong-shaped opening portion of the receiving portion 41.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is (for US):

1. A paper/plastic-film carrier bag, comprising:
a cylindrical receiving portion, which is configured to receive an approximately cubic-shaped article therein; and
a long-shaped handgrip portion, being formed extending from one of upper sides of said cylindrical receiving portion, on a side of which is in contact anyone of sides of said approximately cubic-shaped article, and reaching to another upper side of said cylindrical receiving portion facing thereto.

2. The paper/plastic-film carrier bag, as described in the claim 1, wherein said handgrip portion is formed, starting from the upper side of said receiving portion on the side in contact with a long side of said approximately cubic-shaped article, and reaching to the upper side facing thereto, when said approximately cubic-shaped article is defined by oblong rectangles.

3. The paper/plastic-film carrier bag, as described in the claim 1, wherein said handgrip portion is made by two (2) pieces of long-shaped members, extending from both ends of the upper side of said receiving portion and reaching to both ends of the upper end facing thereto, respectively.

4. The paper/plastic-film carrier bag, as described in the claim 1, wherein said handgrip portion is made by two (2) pieces of long-shaped members, extending from both ends of the upper side of said receiving portion and reaching to both ends of the upper end facing thereto, respectively.

5. A method for manufacturing a plastic-film carrier bag, comprising the following steps of:
a step of producing a fully-closed sack by conducting a welding process on a cylindrical plastic film progressing in an in-line process, for sealing a portion to be a side surface of the plastic-film carrier bag and separating from;
a step of removing an unnecessary portion from one or plural pieces of said fully-closed sack(s) piled up, on a side of a handgrip portion, along one edge thereof being in parallel with a direction of progress of said in-line process; and thereby
manufacturing the plastic-film carrier bag described in the claim 1.

6. A method for manufacturing a plastic-film carrier bag, comprising the following steps of:
a step of conducing a sealing process on a cylindrical plastic film progressing in an in-line process, on a portion to be a side surface of the plastic-film carrier bag;
a step of removing an unnecessary portion from said plastic film after said sealing process, on a side of a handgrip portion, along one edge thereof being in parallel with a direction of progress of said in-line process;
a step of cutting and separating a welding portion or an adhesion portion, which is formed on said plastic film after said sealing process; and thereby
manufacturing the plastic-film carrier bag described in the claim 1.

7. A method for manufacturing a plastic-film carrier bag, comprising the following steps of:
a step of removing an unnecessary from a plastic film progressing in an in-line process, on a side of a handgrip portion along one edge being in parallel with a direction of the progress of said in-line process;
a sealing process on a cylindrical plastic film progressing in an in-line process, on a portion to be a side surface of the plastic-film carrier bag;
a step of cutting and separating a welding portion or an adhesion portion, which is formed on said plastic film after said sealing process; and thereby
manufacturing the plastic-film carrier bag described in the claim 1.

8. The method for manufacturing a plastic-film carrier bag, as described in the claim 5, in place of said welding process, further comprising the following steps:
a step of conducting sealing process on said plastic film after said removing step, for sealing the portion to be the side surface of the plastic-film carrier bag; and
a step of conducting a process for cutting and separating a welding portion or an adhesion portion, which is formed on said plastic film after said sealing process.

9. The method for manufacturing a plastic-film carrier bag, as described in the claim 7, in place of said welding process, further comprising the following steps:
a step of conducting sealing process on said plastic film after said removing step, for sealing the portion to be the side surface of the plastic-film carrier bag; and
a step of conducting a process for cutting and separating a welding portion or an adhesion portion, which is formed on said plastic film after said sealing process.

10. The method for manufacturing a plastic-film carrier bag, as described in the claim 5, further comprising the following step:
a step of forming a folding portion in said cylindrical plastic film, on both or one of edges thereof being in parallel with the direction of progress of said in-line process; and wherein
said folding portion is included in said unnecessary portion, when said folding portion is formed on the side of the handgrip portion of the plastic-film carrier bag.

11. The method for manufacturing a plastic-film carrier bag, as described in the claim 6, further comprising the following step:
a step of forming a folding portion in said cylindrical plastic film, on both or one of edges thereof being in parallel with the direction of progress of said in-line process; and wherein
said folding portion is included in said unnecessary portion, when said folding portion is formed on the side of the handgrip portion of the plastic-film carrier bag.

12. The method for manufacturing a plastic-film carrier bag, as described in the claim 7, further comprising the following step:
a step of forming a folding portion in said cylindrical plastic film, on both or one of edges thereof being in parallel with the direction of progress of said in-line process; and wherein
said folding portion is included in said unnecessary portion, when said folding portion is formed on the side of the handgrip portion of the plastic-film carrier bag.

13. The method for manufacturing a plastic-film carrier bag, as described in the claim 8, further comprising the following step:
a step of forming a folding portion in said cylindrical plastic film, on both or one of edges thereof being in parallel with the direction of progress of said in-line process; and wherein
said folding portion is included in said unnecessary portion, when said folding portion is formed on the side of the handgrip portion of the plastic-film carrier bag.

14. The method for manufacturing a plastic-film carrier bag, as described in the claim 9, further comprising the following step:
a step of forming a folding portion in said cylindrical plastic film, on both or one of edges thereof being in parallel with the direction of progress of said in-line process; and wherein
said folding portion is included in said unnecessary portion, when said folding portion is formed on the side of the handgrip portion of the plastic-film carrier bag.
